(19) United States
(12) Patent Application Publication
(10) Pub. No.: US 2020/0009946 A1
(43) Pub. Date: Jan. 9, 2020

(54) Novel Vehicle with 180-Degree Field of View of Main Driver

(71) Applicant: Wanli Wu, Jinjiang (CN)

(72) Inventor: Wanli Wu, Jinjiang (CN)

(21) Appl. No.: 16/571,209

(22) Filed: Sep. 16, 2019

(30) Foreign Application Priority Data
Feb. 11, 2019 (CN) 201910110327.7

(51) Int. Cl. B60J 1/00; B60J 1/02

(52) U.S. Cl. CPC B60J 1/008; B60J 1/007; B60J 1/02

(57) ABSTRACT

A novel vehicle with a 180-degree field of view of a main driver, wherein front and rear window frames of an integrated main window frame and two side window frames of a main window are adapted in shape and connected to form the integrated main window frame; an integrated main window windshield, made by adjusting the shape, specification and size of the main window windshield until no light reflection or refraction is produced according to the shape, specification and structure of the integrated main window frame, is installed in the integrated main window frame, forming an integrated main window with a 180-degree field of view of the main driver; and guaranteeing that drivers in the main driver position and the co-driver position conveniently enter and exit the left and right front door openings, however, the minimum width of the door openings is 0.5 meters or more.

### TECHNICAL FIELD

The utility model relates to the technical field of vehicle bodies, and particularly relates to a novel vehicle with a 180-degree field of view of a main driver.

### BACKGROUND

Although the shapes of vehicle bodies are diverse at present, most windows are designed identically; specifically, a main window is installed in a main window frame in front of the driver seat, side windows are installed in side window frames, and the main window is separated from the side windows by door and window frames. Since the positions of the door and window frames are normally within the left and right field of view in front of the main window, the driver is greatly affected, and the safety of driving is greatly affected when turning left or right during driving. Therefore, the problem urgently to be solved by those skilled in, the art is how to, provide a vehicle body structure capable of solving the technical problem.

### SUMMARY

In view of this, the utility model discloses a novel vehicle with a 180-degree field of view of a main driver. By leveling front and rear sections of main window frames of a main window and left and right door and window frames in front of the main window in the rear end direction to adjusting bends on the main driver side and the co-driver side to be connected to upper door frames of the two front doors of the vehicle, the main window frames on the four sides are adapted in shape and connected to form an integrated main window frame; the integrated main window windshield, made by adjusting the shape, specification and size of the main window windshield, until no light reflection or refraction is produced according to the shape, specification and structure of the integrated main window frame, is installed in the integrated main window frame, forming an integrated main window with a 180-degree field of view of a main driver, and guaranteeing that drivers in the main driver position and the co-driver position conveniently enter and exit the front door openings at the left and right sides, wherein the minimum width of the door openings is greater than 0.5 meter. The two front doors are made using the specification and size of the two front door openings of the vehicle, and the side windows are installed in the side window frames. In such a structure, a novel vehicle having an integrated main window with a 180-degree field of view of a main driver is formed.

The utility model has the advantageous effects: for the problems that the field of view of the driver when turning left or right during driving is affected, and then a lot of serious traffic accidents are caused due to the fact that the left and right door and window frames are horizontally and vertically installed in front of the main window of a century old-model vehicle, by leveling front and rear sections of main window frames of a main window and left and right door and window frames in front of the main window in the rear end direction to adjusting bends on the main driver side and the co-driver side to be connected to upper door frames of the two front doors of the vehicle, the main window frames on the four sides are adapted in shape and connected to form an integrated main window frame, and the integrated main window windshield, made by adjusting the shape, specification, and size of the main window windshield until no light, reflection or refraction is produced according to the shape, specification and structure of the integrated main window frame, is installed in the integrated main window frame, forming an integrated main window. Such a structure may make the field of view of the driver reach about 180 degrees, and may also guarantee that drivers in the main driver position and the co-driver position conveniently enter and exit the front door openings at the left and right sides, wherein the minimum width of the door openings is greater than 0.5 meter. Two side windows are installed in the side window frames of the two front doors. The novel vehicle of such a structure has the advantages that the problem that door and window frames are horizontally and vertically installed on the left and right sides in front of a main window is greatly avoided, the field of view of the driver of a century old-model vehicle which is less than 90 degrees is improved to the field of view of the driver of the novel vehicle which is about 180 degrees, various accidents caused by narrow field of view of the old-model vehicle are greatly reduced, and the safety of the novel vehicle is increased.

### DESCRIPTION OF DRAWINGS

To more clearly describe the technical solutions in the embodiments of the utility model or in the prior art, the drawings required to be used in the description of the embodiments or the prior art will be simply presented below. Apparently, the drawings in the following description are merely embodiments of the utility model, and for those ordinary skilled in the art, other drawings can also be obtained according to the drawings without contributing creative labor.

FIG. 1 is a structural schematic diagram of an integrated main window windshield provided by the utility model; and

FIG. 2 shows a main window frame, door opening and side window frame provided by the utility model.

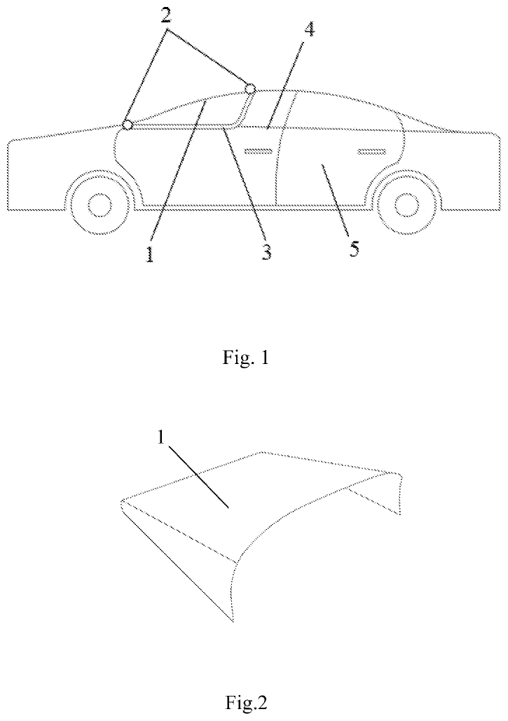

Legends: 1. Integrated Main Window Windshield; 2. Front and Rear Sections of Main Window Frames of Main Window; 3. Main Window Frames on Left and Right Sides of Main Window; 4. Two Side Window Frames of Two Front Doors; 5 Vehicle Body.

### DETAILED DESCRIPTION

Technical solutions in embodiments of the utility model will be clearly and, fully described below. Apparently, the described embodiments are merely part of the embodiments of the utility model, not all of the embodiments. Based on the embodiments in the utility model, all other embodiments obtained by those ordinary skilled in the art without contributing creative labor will belong to the protection scope of the utility model.

Embodiments of the utility model disclose a novel vehicle with a 180-degree field of view of a main driver, comprising a vehicle body 5 including front and rear window frames 2 of an integrated main window frame and left and right door and window frames in front of the main window, which are leveled in the rear end direction to adjusting bends on the main driver side and the co-driver side to be connected to upper door frames of the two front doors. The main window frames on the four sides are adapted in shape and connected to form an integrated main window frame; the integrated main window windshield, made by adjusting the shape, specification and size of the main window windshield until no light reflection or refraction is produced according to the shape, specification and structure of the integrated main window frame, is installed in the integrated main window frame, forming an integrated main window with a 180-degree field of view of a main driver, and guaranteeing that drivers in the main driver position and the co-driver position conveniently enter and exit the front door openings at the left and right sides, wherein the minimum width of the door openings is greater than 0.5 meter. The two front doors are made using the specification and size of two front door openings of the vehicle; and the side windows are installed in the side window frames 4.

The utility model provides a vehicle body structure which widens the field of view of a main window. For the problem that the left or right field of view in front of the main window when the driver drives is greatly affected due to the fact that the door and window frames of the old-model vehicle are horizontally and vertically installed on the left and right sides n front of the main window, by leveling the door and window frames horizontally installed on the left and right sides in front of a main window in the rear end direction to adjusting bends on the main driver side and the co-driver side to be connected to upper door frames of the two front doors, the front and rear sections of main window frames of the main window and main window frames on the left and right sides of the main window are adapted in shape and connected to form an integrated main window frame, and the integrated main window windshield is installed in the integrated main window frame, faulting an integrated main window with a 180-degree field of view of a main driver, and guaranteeing that drivers in the main driver position and the co-driver position conveniently enter and exit the front door openings at the left and right sides, wherein the minimum width of the door openings, is greater than 0.5 meter. The two front doors are made using the specification and size of the two front door openings, and the side windows are installed in the side window frames 4. Such a structure may make the field of view of the driver be greatly increased to about 180 degrees, meanwhile, may reduce various serious accidents caused by insufficient field of view of an old-model vehicle, and may greatly increase the safety of driving for the novel vehicle with a 180-degree field of view of a main driver.

Each embodiment in the description is described in a progressive way. The difference of each embodiment from each other is the focus of explanation. The same and similar parts among all of the embodiments can be referred to each other. For the apparatus disclosed by the embodiment, because the apparatus corresponds to the method disclosed by the embodiment, the apparatus is simply described. Refer to part of the description of the method for the related part.

The above description of the disclosed embodiments enables those skilled in the art to realize or use the utility model. Many modifications to these embodiments will be apparent to those skilled in the art. The general principle defined herein can be realized in other embodiments without departing from the spirit or scope of the utility model. Therefore, the utility model will not be limited to these embodiments shown herein, but will conform to the widest scope consistent with the principle and novel features disclosed herein.

1. A novel vehicle with a 180-degree field of view of a main driver, wherein front and rear window frames (2) of an integrated main window frame and two side window frames (3) of a main window are adapted in shape and connected to form the integrated main window frame; an integrated main window windshield, made by adjusting the shape, specification and size of the main window windshield until no light reflection or refraction is produced according to the shape, specification and structure of the integrated main window frame, is installed in the integrated main window frame, forming an integrated main window with a 180-degree field of view of the main driver; and guaranteeing that drivers in the main driver position and the co-driver position conveniently enter and exit the front door openings at the left and right sides, wherein the minimum width of the door openings is greater than 0.5 meter, the two front doors are made using the specification and size of the two front door openings of the vehicle, and the side windows are installed in the side window frames (4).

2. A novel vehicle with a 180-degree field of view of a main driver according to claim 1, wherein the integrated main window windshield, made by adjusting the shape, specification and size of the main window windshield until no light reflection or refraction is produced according to the shape, specification and structure of the integrated main window frame, is installed in the integrated main window frame, so that a novel vehicle having an integrated main window with a 180-degree field of view of the main driver is formed by means of such a structure.

3. A novel vehicle with a 180-degree field of view of a main driver according to claim 1, wherein it is also guaranteed that drivers in the main driver position and the co-driver position conveniently enter and exit the front door openings at the left and right sides, wherein the minimum width of the door openings is 0.5 meters or more; the two front doors are made using the specification and size of the two front door openings; and the side windows are installed, in the side window frames (4).
